(19) United States
(12) Patent Application Publication
(10) Pub. No.: US 2007/0012772 A1
(43) Pub. Date: Jan. 18, 2007

(54) Plastic case for an EAS tag

(76) Inventor: William J. Cooper, Woonsocket, RI (US)

Correspondence Address: KRIEGSMAN & KRIEGSMAN, 30 TURNPIKE ROAD, SUITE 9, SOUTHBOROUGH, MA, 01772, US

(21) Appl. No.: 11/348,511

(22) Filed: Feb. 6, 2006

Related U.S. Application Data
(60) Provisional application No. 60/700,125, filed on Jul. 18, 2005.

(51) Int. Cl. G06K 7/00

(52) U.S. Cl. 235/435; 340/572.8

(57) ABSTRACT

A unitary plastic case includes a base and a cover that are pivotally coupled together by a hinge. In this manner, the plastic case is capable of being pivoted about the hinge between an open position and an enclosed position. With the plastic case disposed in its enclosed position, the base and cover are sized and shaped to substantially encapsulate a conventional EAS tag. In one embodiment, the plastic case additionally includes a pair of integrally formed mounting straps, each strap being shaped to include a plurality of ratchet teeth. Furthermore, the plastic case is shaped to define a pair of slots, each slot being sized and shaped to receive an associated mounting strap, the plastic case being shaped to sequentially engage the plurality of ratchet teeth on each mounting strap as each mounting strap is fed through its associated slot. In another embodiment, the plastic case additionally includes a pair of projections, each projection defining a slot that is sized and shaped to fittingly receive the strap of a conventional cable tie. In another embodiment, the plastic case additionally includes a separable bushing which is sized and shaped to mount within an elongated bore formed in the plastic case. With the bushing mounted within the elongated bore, the bushing is free to rotate independently of the remainder of the plastic case.

### CROSS-REFERENCE TO RELATED APPLICATIONS

The present application claims the benefit under 35 U.S.C. 119(e) of U.S. provisional Patent Application Ser. No. 60/700,125, filed Jul. 18, 2005, the disclosure of which is incorporated herein by reference.

### BACKGROUND OF THE INVENTION

The present invention relates generally to security devices for articles of commerce and more particularly to electronic article surveillance (EAS) devices.

In the retail industry, numerous measures are typically employed by retail stores to minimize the risk of merchandise theft. As an example, security devices are often affixed to articles of commerce to minimize the risk of product theft.

Electronic article surveillance (EAS) devices (also commonly referred to as EAS tags, EAS labels or EAS markers) are well known and commonly used in the retail industry as security devices. Specifically, in a traditional retail environment (e.g., a retail store), an individual EAS label is affixed to each article of commerce that requires security monitoring. An EAS reader, located at the point of egress in the retail store, operates at a limited range (e.g., the immediate area of the store entrance/exit). The EAS reader continuously sends out an interrogation signal, said signal being either acousto-magnetic, electro-magnetic or radio frequency in nature. When the EAS tag passes within range of the EAS reader (e.g., when the consumer is passing through the exit), the EAS tag detects the interrogation signal and becomes active. When activated, the EAS tag transmits a response signal which is detected by the reader. In response thereto, the reader provides an indication of potential merchandise theft (e.g., an audible and/or visual alarm). In this manner, products provided with an EAS tag can be monitored as said products pass through the entrance/exit of a retail store. Preferably, the check-out/purchase area of the store is provided with a de-activation device to permanently disarm EAS tags which are affixed to products that have been paid for by the consumer.

One type of EAS label which is commonly used in the retail industry is shown in FIG. 1, said EAS label being identified by reference numeral 11. EAS label 11 includes electromagnetic materials 13 which are at least partially encased within a soft plastic housing 15. An adhesive layer 16 is commonly affixed to the underside of soft plastic housing 15 to enable EAS label 11 to be fixedly secured to an article of commerce (or, in the alternative, to the packaging for said article).

As can be appreciated, it has been found that soft plastic housing 15 inadequately protects the relatively sensitive electromagnetic materials 13 which are enclosed therewithin. In particular, it has been found that the application of a mild amount of pressure on top surface 17 of soft plastic housing 15 (such as through light manual handling of EAS label 11) can significantly damage electromagnetic materials 13 to the extent where EAS label 11 becomes inoperative, which is highly undesirable.

Accordingly, it is known in the art for a hard plastic case to be used to encapsulate EAS label 11 and thereby protect label 11 from potentially damaging conditions. Specifically, the hard nature of such a plastic case adequately protects the sensitive electromagnetic materials 13 contained within EAS label 11 from the application of any potentially harmful pressure. In addition to its protective feature, the hard plastic case may also serve to disguise EAS tag 11. As can be appreciated, with consumers unaware of the existence of EAS tag 11, the propensity for EAS tag tampering is minimized, which is highly desirable.

One type of plastic casing for an EAS tag which is well known in the art includes a base and a cover which are separately molded and which, in a subsequent step, can be fused together (e.g., through an ultrasonic welding process) to encapsulate EAS tag 11. Such a casing also commonly includes a single bore through which a fastening device can be inserted. Typically, such a fastening device is of the type which can be formed into a closed loop (e.g., a standard 4 inch cable tie). In this manner, by inserting one end of the fastening device through the bore as well as around/through a desired article of commerce (e.g., a watch, a briefcase, an article of clothing, etc.) and then securing the fastening device into a closed loop, the fastening device serves to couple together the article of commerce with the plastic case (and, in turn, the EAS tag 11 retained therein).

In the present invention, applicant has recognized that the prior art plastic case described above suffers from a few notable drawbacks.

As a first drawback, it has been found that method for encapsulating an EAS tag using the above-described plastic case is relatively time-consuming and labor intensive. Specifically, as noted above, the base and cover for said case are typically manufactured as two separate pieces which are, in turn, fused together to encapsulate the EAS tag 11. As can be appreciated, it has been found that the need for a fusing process during the assembly of the plastic casing serves to significantly complicate the manufacturing process, thereby resulting in considerable increase in manufacturing costs, which is highly undesirable.

As a second drawback, it has been found that the means by which the above-described plastic case may be affixed to a product is somewhat labor-intensive. Specifically, the requirement that a laborer feed a separate fastening device (which may or may not be readily available) through the bore in the casing and, in a subsequent step, form said fastening device into a closed loop, is considerably time-consuming, which is highly undesirable.

As a third drawback, it has been found that the particular design of the above-described plastic case inherently allows for the fastening device used in conjunction therewith to be easily severed. Specifically, it has been found that unscrupulous consumers often tamper with the fastening device by twisting the plastic case about the longitudinal axis defined by its bore using a minimal amount of torque. Twisting the plastic case causes the fastening device to similarly twist. In fact, the plastic case can be twisted until the stress exerted on the fastening device causes it to snap. With the fastening device severed, the plastic case (as well as EAS label 11) can be separated from the product, thereby rendering said product free from security protection, which is highly undesirable.

### SUMMARY OF THE INVENTION

It is an object of the present invention to provide a new and improved plastic case for an electronic article surveillance (EAS) tag.

It is another object of the present invention to provide a new and improved plastic case which at least partially encapsulates an EAS tag for protective purposes.

It is yet another object of the present invention to provide a plastic case of the type as described above which can be easily and securely affixed to an article of commerce.

It is yet still another object of the present invention to provide a plastic case as described above which has a limited number of parts, which is inexpensive to manufacture and which is easy to use.

Accordingly, as one feature of the present invention, there is provided a plastic case for encapsulating an EAS tag, the plastic case comprising (a) a base, and (b) a cover pivotally coupled to the base by a hinge, the hinge enabling the plastic case to be disposed between an open position and an enclosed position, wherein, with the plastic case disposed in its enclosed position, the base and cover are sized and shaped to substantially encapsulate the EAS tag.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a top perspective view, broken away in part, of an EAS device which is well known in the art;

FIG. 2 is a top perspective view of one embodiment of a plastic case for an EAS device that is constructed according to the teachings of the present invention,

FIGS. 3(a) -(c) are bottom perspective views of the plastic case shown in FIG. 1 at various stages during the process of encapsulating an EAS device therewithin;

FIGS. 4(a)-(c) are bottom perspective views of the enclosed plastic case shown in FIG. 3(c) at various stages during the process of securing said case onto a cable;

FIG. 5 is a top perspective view of another embodiment of a plastic case for an EAS device that is constructed according to the teachings of the present invention, the case being shown in its open position;

FIG. 6 is a top perspective view of another embodiment of a plastic case for an EAS device that is constructed according to the teachings of the present invention, the case being shown in its open position;

FIG. 7 is a top perspective view of another embodiment of a plastic case for an EAS device that is constructed according to the teachings of the present invention, the case being shown in its open position;

FIG. 8 is a top perspective view of another embodiment of a plastic case for an EAS device that is constructed according to the teachings of the present invention, the case being shown in its open position; and

FIGS. 9(a)-(d) are top perspective views of the plastic case shown in FIG. 8 at various stages during the process of securing said case to an object, the plastic case being shown in its closed position.

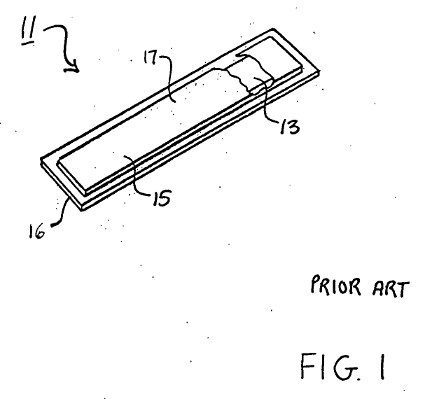

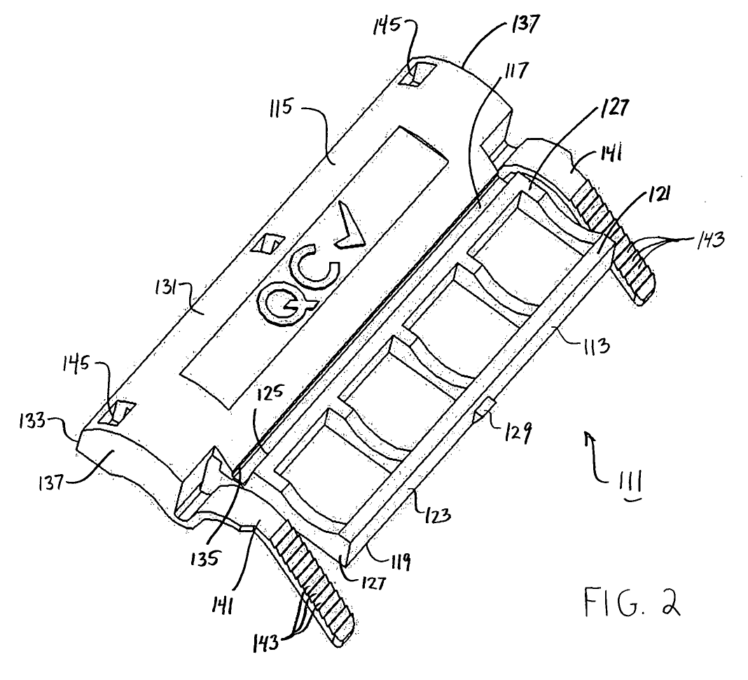

### DETAILED DESCRIPTION OF THE PREFERRED EMBODIMENT

Referring now to FIG. 2, there is shown a top perspective view of a first embodiment of a plastic case for encapsulating an EAS tag, said plastic case being constructed according to the teachings of the present invention and identified generally by reference numeral 111. As will be described further below, plastic case 111 is designed to perform the following two functions: (1) to encapsulate conventional EAS tag 11 (i.e., for protective purposes) and (2) to enable said encapsulated EAS tag 11 to be securely coupled to a particular object (e.g., such as a cable or an article of commerce).

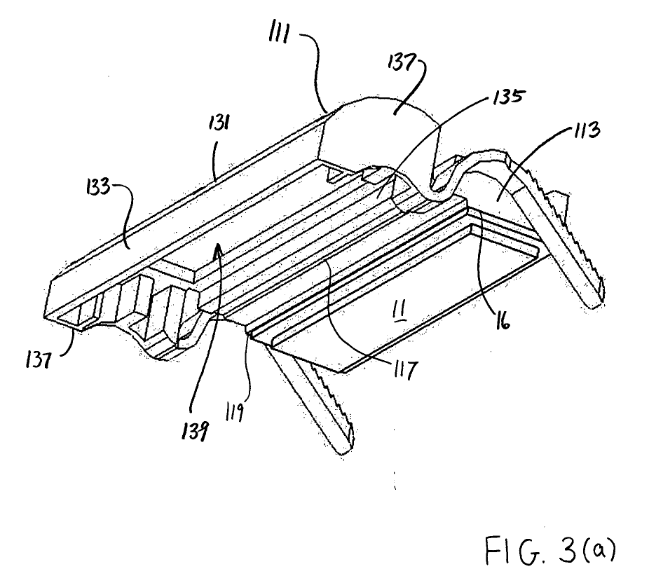

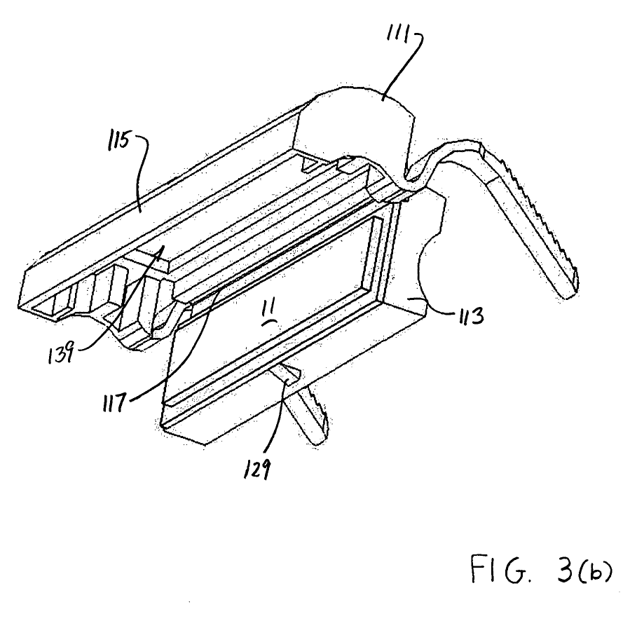

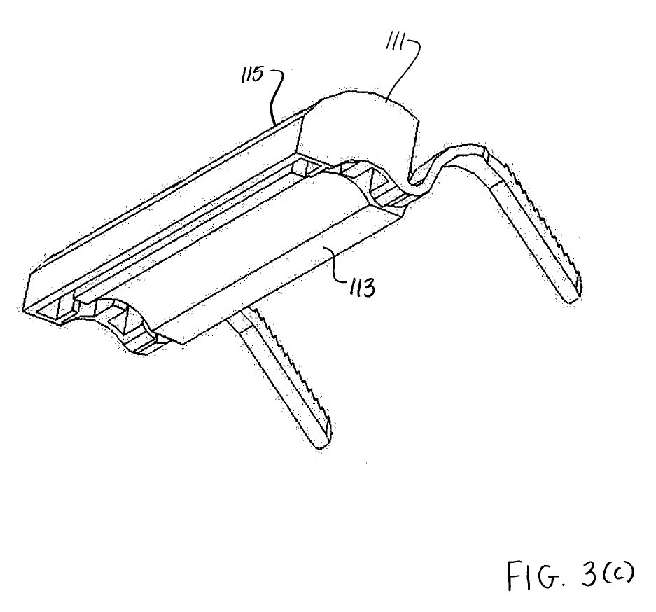

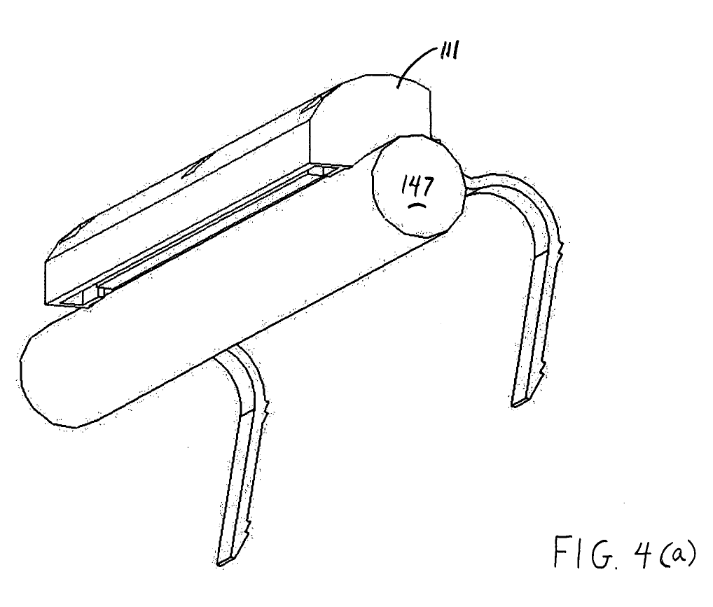

Plastic case 111 is a unitary device that is constructed out of rigid and durable plastic using conventional molding techniques. Case 111 comprises a base 113 and a cover 115 which are pivotally coupled together by means of a living hinge, or bend line, 117. In this manner, plastic case 111 is capable of being disposed between an open position (as represented in FIG. 2) and an enclosed position (as represented in FIG. 3(c)) in which an EAS device 11 may be encapsulated therein, as will be described further in detail below.

Base 113 is a substantially rectangular member which includes a flat top surface 119 that is adapted to receive the adhesive layer of EAS device 11, a bottom surface 121, a front wall 123, a rear wall 125 and a pair of sidewalls 127. In addition, a ratchet-shaped locking finger 129 is formed on front wall 123 and serves as a simple mechanical means for retaining case 111 in its enclosed position.

Cover 115 is a rounded, hollowed-out member that includes a curved top surface 131, a shortened front wall 133, a shortened rear wall 135 and a pair of sidewalls 137 and 137 which together define a partially enclosed interior cavity 139 (as seen most clearly in FIG. 3(a)). Identifying matter (represented in FIG. 2 as “QC√”) may be formed (i.e., molded) into top surface 131 to provide information relating to the product to which case 111 is ultimately affixed.

A pair of mounting straps 141 are integrally formed onto opposite ends of rear wall 135, each mounting strap 141 being provided with a plurality of ratchet teeth 143 on its top surface. As will be described further below, each mounting strap 141 is adapted to be inserted through a corresponding slot 145 formed in top surface 131 of cover 115 so as to form a closed loop, with a ratchet tooth 143 on each strap 141 engaging a notch (not shown) formed on the inner surface of front wall 133 to retain each strap 141 in its closed loop configuration. In this manner, straps 141 can be used to retain plastic casing 111 on various sized cylindrical members.

As noted above, plastic casing 111 can be used to encapsulate EAS device 11 and, in turn, secure encapsulated device 11 to a cylindrical product. Details relating to said encapsulation and securement processes are described in detail herein.

Referring now to FIGS. 3(a)-(c), plastic casing 111 can be used in the following manner to encapsulate EAS tag 11. Specifically, with plastic casing 111 disposed in its open position, adhesive layer 16 of EAS tag 11 is affixed to top surface 119 of base 113, as shown in FIG. 3(a). With sensor 11 mounted thereon, base 113 is then pivoted about hinge 117 in the direction towards cover 115, as shown in FIG. 3(b). Base 113 and cover 115 are appropriately dimensioned such that, as base 113 continues to rotate about hinge 117, the majority of base 113 ultimately locates within interior cavity 139, as shown in FIG. 3(c). With base 113 positioned within cover 115 as such, casing 111 is said to be in its enclosed position. It should be noted that, with casing 111 disposed in its closed position, locking finger 129 on base 113 engages a shoulder (not shown) formed in cover 115 so as to lockably retain plastic case 111 in its closed position with EAS tag 11 trapped therewithin, which is highly desirable.

It is to be understood that the above-described process by which one-piece casing 111 can be pivoted into its enclosed position and locked in place by means of a snap-fit engagement is significantly less labor intensive than prior art means which require the fusion of two separate plastic members. Consequently, the encapsulation of EAS device 11 using a unitary, pivotable and lockable plastic casing serves as a principal novel feature of the present invention.

It should be noted that, for simplicity purposes only, plastic case 111 was described for use in encapsulating EAS tag 11. However, it is to be understood that case 111 is not limited to use with EAS tag 11. Rather, case 111 could be used to encapsulate alternative types of security devices which are similar in size and shape to EAS tag 11 without departing from the spirit of the present invention.

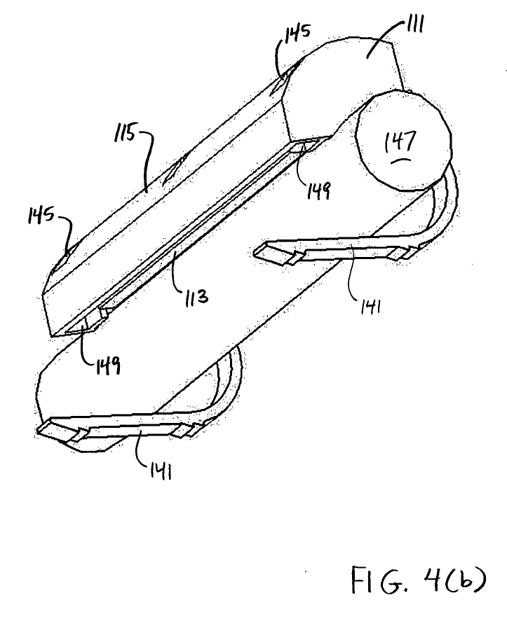

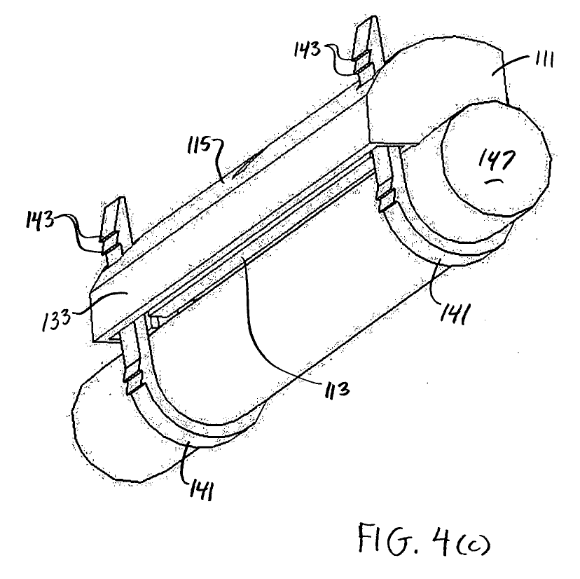

Referring now to FIGS. 4(a)-(c), plastic casing 111 can, in turn, be used in the following manner to secure the encapsulated EAS tag 11 onto a cylindrical object 147, such as a cable. Specifically, with plastic casing 111 retained in its enclosed position (i.e., with EAS tag 11 encapsulated therein), the underside of plastic casing 111 is disposed longitudinally on top of object 147, as shown in FIG. 4(a). Preferably, bottom surface 121 of base 113 as well as sidewalls 137 of cover 115 are provided with a longitudinal curvature (as seen most clearly in FIG. 3(c)) to facilitate in the mounting of casing 111 on object 147. With plastic case 111 disposed on object 147, each mounting strap 141 for plastic case 111 is wrapped around object 147, as shown in FIG. 4(b). The free end of each mounting strap 141 is then directed into a corresponding channel 149 that is formed between base 113 and cover 115, thereby causing each strap 141 to form a closed loop around object 147. As each strap 141 is advanced into its associated channel 149, the straps 141 cinch tightly around object 147, with the free end of each strap 141 ultimately exiting through a corresponding slot 145 in cover 115, as shown in FIG. 4(c). As noted briefly above, teeth 143 on each mounting strap 141 sequentially engage a fixed shoulder (not shown) that is formed on the inner surface of front wall 133 in order to lockably retain each strap 141 cinched tightly around object 147, the relatively sharp angle of each tooth 143 serving to create a strong level of engagement with the fixed shoulder. As can be appreciated, the large number of teeth 143 provided on each strap 141 enables plastic case 111 to be mounted on various sized objects 147, which is highly desirable.

It is to be understood that the provision of an integrated pair of mounting straps 141 to retain plastic casing 111 against cylindrical object 147 provides plastic casing 111 with two notable advantages over prior art sensor casings of the type as described above (i.e., which do not include integrated mounting straps).

As a first advantage, the integration of fastening means (i.e., straps 141 ) directly into plastic case 111 facilitates the process of mounting case 111 onto a desired object. In particular, it is to be understood that the user is not required to locate and/or feed separate cable ties through the casing 111 during the mounting process, which is highly desirable.

As a second advantage, the use of two opposing straps 141 to secure casing 111 to an object serves to create a strong retention force that can not be broken through manipulation (e.g., twisting) of the sensor casing 111, which is highly desirable.

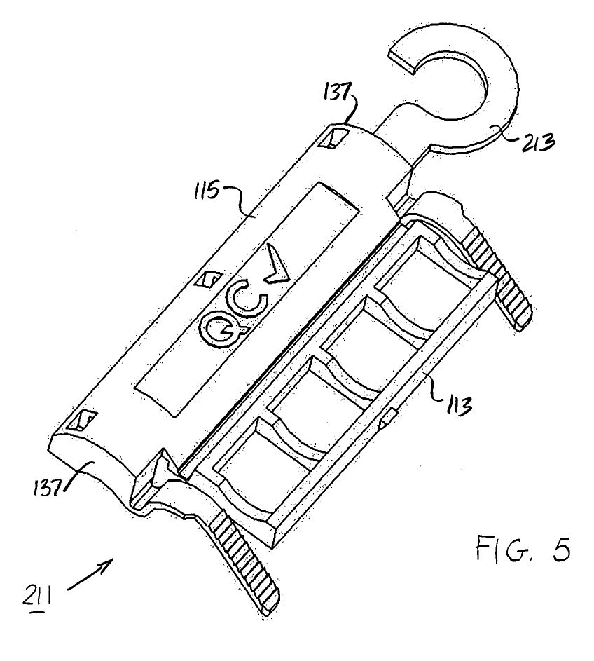

Referring now to FIG. 5, there is shown a top perspective view of a second embodiment of a plastic case for encapsulating an EAS device, said plastic case being identified generally by reference numeral 211.

Plastic case 211 is identical in all respects with plastic case 111 with the one notable exception being that plastic case 211 additionally includes a hook 213 that is sized and shaped to be removably mounted on a wire or other similar object. Hook 213 is preferably integrally formed onto either sidewall 137 of cover 115 and is disposed to extend out at an approximate right angle relative thereto. Accordingly, with plastic case 211 encapsulating an EAS device 11 (as described above) and, in turn, retained against an object 147 (as described above), it is to be understood that hook 213 serves as a means for enabling the object 147 against which plastic case 211 is retained to be hung for display purposes (e.g, in a retail environment), which is highly desirable.

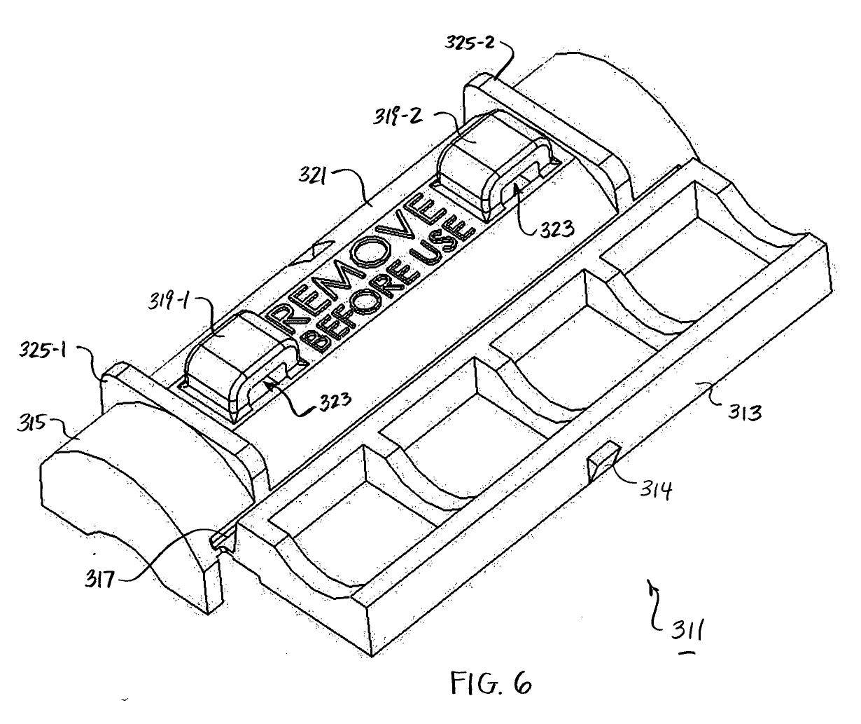

Referring now to FIG. 6, there is shown a top perspective view of a third embodiment of a plastic case for encapsulating an EAS device, said plastic case being identified generally by reference numeral 311.

Plastic case 311 is similar to plastic case 111 in that plastic case 311 includes a base 313 and a cover 315 that are pivotally coupled together by means of a living hinge 317. Accordingly, plastic case 311 is capable of being disposed between an open position (as represented in FIG. 6) and a closed position, with case 311 being sized and shaped to encapsulate an EAS device 11 therewithin when case 311 is disposed in its closed position. Similar to case 111, plastic case 311 includes a ratchet-shaped locking finger 314 which engages a complementary shoulder (not shown) formed in cover 315 so as to lockably retain plastic case 311 in its closed position by means of a snap-fit interrelationship when case 311 is configured as such.

The principal distinction between plastic case 311 and plastic case 111 lies in the fact that plastic case 311 does not include a pair of integrally formed mounting straps. In place thereof, cover 315 is provided with a pair of spaced apart projections 319-1 and 319-2 which protrude up from its top surface 321, each projection 319 being hollowed out so as to define a longitudinal, strap-accepting slot 323 which is generally rectangular in lateral cross-section.

As can be appreciated, each slot 323 is sized and shaped to fittingly receive the strap of a conventional cable tie (e.g., a conventional 4 inch cable tie). In this manner, with plastic case 311 disposed in its closed position (preferably with an EAS tag 11 encapsulated therewithin), a pair of conventional cable ties can be fed through slots 323 and cinched into a closed loop around a desired object in order to securely retain plastic case 311 against said object.

It should be noted that cover 315 is additionally provided with a pair of retention ribs 325-1 and 325-2 which protrude up from its top surface 321. As can be seen, each retention rib 325 extends along at least the majority of the width of cover 315. It should be noted that each retention rib 325 is positioned outside of its corresponding projection 319 (i.e., such that both projections 319 are located between the pair of retention ribs 325). As such, with a pair of cable ties fed through slots 323 and cinched into closed loops, it is to be understood that ribs 325 help retain the pair of cable ties in their proper placement relative to case 311 (i.e., extending transversely therearound).

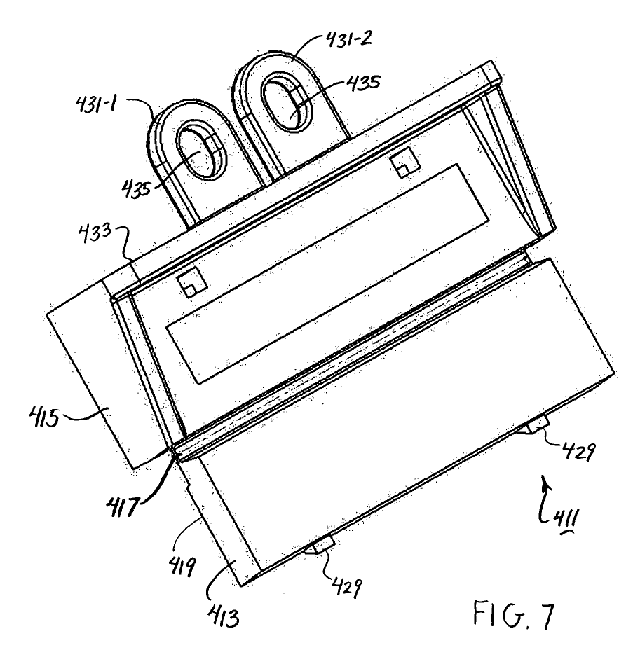

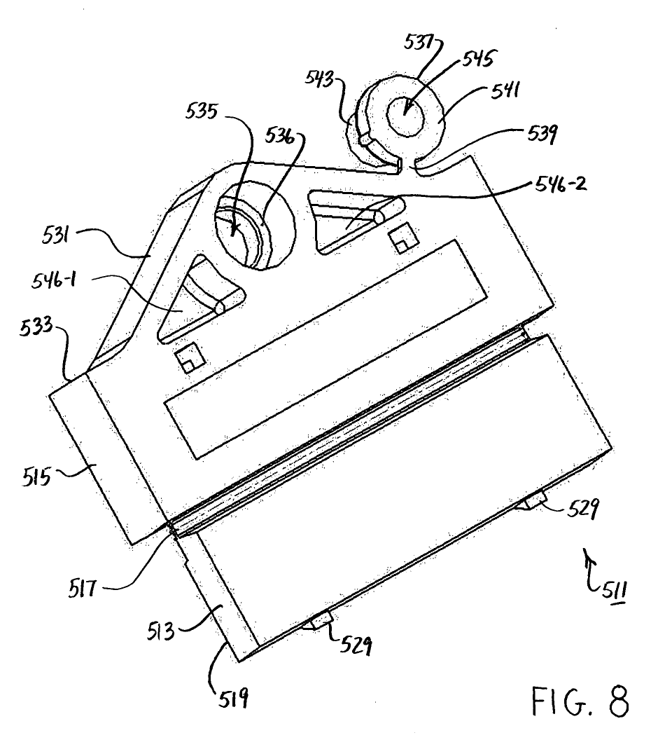

Referring now to FIG. 7, there is shown a top perspective view of a fourth embodiment of a plastic case for encapsulating an EAS device, said plastic case being identified generally by reference numeral 411.

Plastic case 411 is similar to plastic case 111 in that plastic case 411 includes a base 413 and a cover 415 which are pivotally coupled together by means of a living hinge, or bend line, 417. In this manner, plastic case 411 is capable of being disposed between an open position (as represented in FIG. 7) and an enclosed position.

As can be appreciated, plastic case 411 can be used in a similar manner to plastic case 111 to encapsulate an EAS device 11. Specifically, with plastic case 411 disposed in its open position, adhesive layer 16 of EAS tag 11 is affixed to top surface 419 of base 413. With sensor 11 mounted thereon, base 413 is then pivoted about hinge 417 in the direction towards cover 415. Base 413 and cover 415 are appropriately dimensioned such that, as base 413 continues to rotate about hinge 417, the majority of base 413 ultimately locates within an interior cavity (not shown) that is defined within the underside of cover 415. With base 413 positioned within cover 415 as such, casing 411 is said to be in its enclosed position and sensor 11 is completely encapsulated therewithin. It should be noted that casing 411 is retained in its closed position by means of a snap-fit engagement between a pair of ratchet shaped fingers 429 on base 413 and a pair of complementary shoulders (not shown) formed on the inner surface of cover 415.

Plastic case 411 differs primarily from plastic case 111 in that plastic case 411 is provided with an alternative means for securing it to an object (i.e., other than by means of a pair of integrally formed mounting straps). Specifically, plastic case 411 is provided with a pair of spaced apart mounting tabs 431-1 and 431-2. Each mounting tab 431 extends orthogonally out from front wall 433 of cover 415 and is shaped to define an oval-shaped hole 435.

In use, plastic case 411 may be secured to an object (e.g., a flat panel) in the following manner. Specifically, with case 411 disposed in its closed position (preferably with an EAS tag 11 encapsulated therein), a threaded fastening element (e.g., a screw, bolt, etc.) is disposed through each hole 435, the fastening element preferably having an enlarged head at one of its ends that is sized and shaped to contact its corresponding mounting tab 431. Disposed as such, the leading end of the fastening element is driven into the particular object (e.g., the flat panel) to which plastic case 411 needs to be secured.

It should be noted that the provision of two spaced apart mounting tabs 431 provides plastic case 411 with a notable advantage which serves a principal novel feature of the present invention. Specifically, because a pair of threaded fastening elements is used to secure plastic case 411 to an object, case 411 is incapable of being pivoted about the longitudinal axis defined by either fastening element. As a result, an unscrupulous consumer would thereby be unable to unscrew (i.e., separate) the plastic case 411 (and the EAS tag 11 retained therein) from the object by simply rotating plastic case 411 about a fastening element. To the contrary, if a single, threaded, fastening element were utilized to secure plastic case 411 to an object, it is to be understood that an unscrupulous consumer could rotate case 411 about the longitudinal axis defined by said fastening element which would, in turn, cause the fastening element to unscrew from the object. Stated another way, an EAS case with a single mounting tab would enable an unscrupulous consumer to use the plastic case as a tool for unscrewing the fastening element from the monitored object (whereas the dual-tab construction of plastic case 411 prevents its use as a tool for separating an encapsulated EAS tag from the object in need of security monitoring).

Referring now to FIG. 8, there is shown a top perspective view of a fifth embodiment of a plastic case for encapsulating an EAS device, said plastic case being identified generally by reference numeral 511.

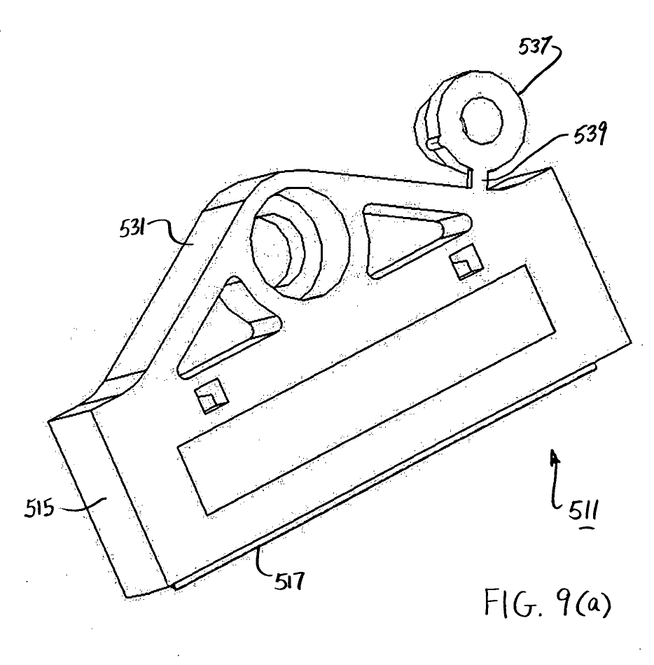

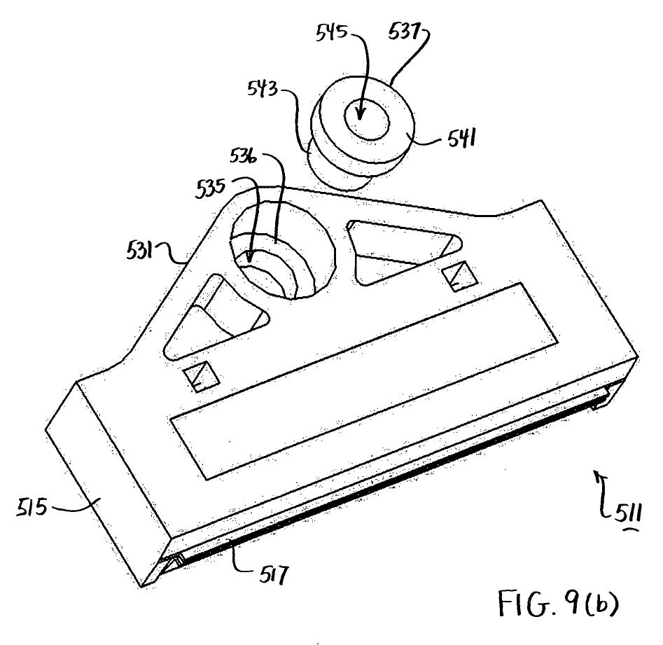

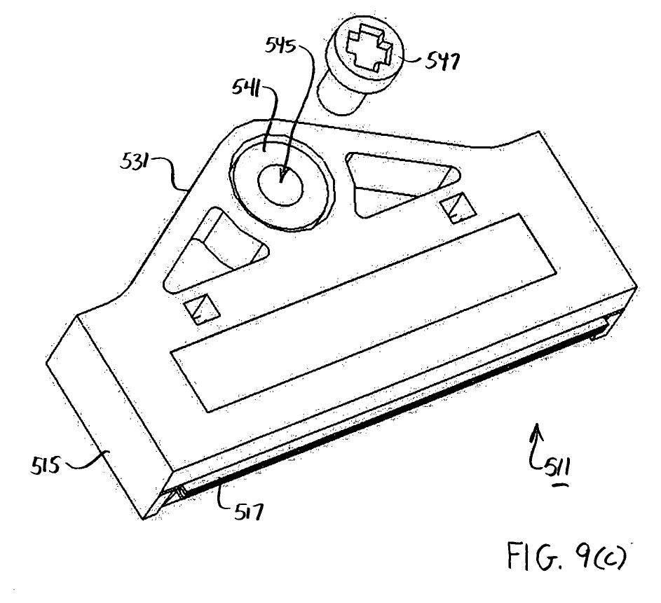

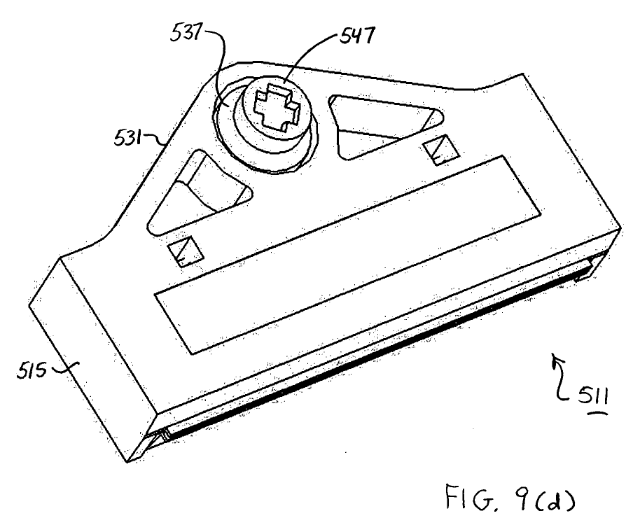

Plastic case 511 is similar to plastic case 411 in that plastic case 511 includes a base 513 and a cover 515 which are pivotally coupled together by means of a living hinge, or bend line, 517. In this manner, plastic case 511 is capable of being disposed between an open position (as represented in FIG. 8) and an enclosed position (as represented in FIG. 9(a)).

As can be appreciated, plastic case 511 can be used in a similar manner to plastic case 411 to encapsulate an EAS device 11. Specifically, with plastic case 511 disposed in its open position (as shown in FIG. 8), adhesive layer 16 of EAS tag 11 is affixed to top surface 519 of base 513. With sensor 11 mounted thereon, base 513 is then pivoted about hinge 517 in the direction towards cover 515. Base 513 and cover 515 are appropriately dimensioned such that, as base 513 continues to rotate about hinge 517, the majority of base 513 ultimately locates within an interior cavity (not shown) that is provided in the underside of cover 515. With base 513 positioned within cover 515 as such, casing 511 is said to be in its enclosed position (as represented in FIG. 9(a)) and sensor 11 is completely encapsulated therewithin. It should be noted that casing 511 is retained in its closed position by means of a snap-fit engagement between a pair of ratchet shaped fingers 529 on base 513 and a pair of complementary shoulders (not shown) formed on the inner surface of cover 515.

Plastic case 511 differs primarily from plastic case 411 in that plastic case 511 is provided with an alternative means for securing it to an object (i.e., other than by means of a pair of spaced apart mounting tabs). Specifically, as seen most clearly in FIG. 8, plastic case 511 is provided with a single, triangular mounting tab 531 that extends orthogonally out from front wall 533 of cover 515, mounting tab 531 extending nearly the entire length of front wall 533.

Mounting tab 531 is shaped to define an elongated bore 535 that extends transversely therethrough (i.e., from its top surface to its bottom surface), bore 535 being generally circular in lateral cross-section. Furthermore, the portion of the top surface of mounting tab 531 that immediately surrounds elongated bore 535 is countersunk so as to define an annular shelf 536.

An annular bushing 537 is integrally molded onto the side of mounting tab 531 by a thin, severable connector 539. Bushing 537 is a unitary member which includes an enlarged annular head 541 and an elongated annular stem 543 which are co-axially aligned and which together define a bore 545 that is uniformly circular in lateral cross-section along its length.

The top surface of mounting tab 531 is additionally shaped to define a pair of generally triangular recesses 546-1 and 546-2, recesses 546 being located on opposite sides of elongated bore 535. As can be appreciated, recesses 546 minimize the amount of material required to manufacture plastic case 511, which is highly desirable.

Plastic case 511 can be used to secure an EAS device to an object (e.g., a flat panel) in the following manner. Specifically, case 511 is first configured into its closed position with an EAS device (e.g., EAS tag 11) encapsulated therein, as shown in FIG. 9(a). Bushing 537 is then manipulated relative to mounting tab 531 until thin connector 539 severs (e.g., by twisting bushing 537 relative to mounting tab 531). With bushing 537 now separated from mounting tab 531, stem 543 of bushing 537 is disposed into axial alignment with elongated bore 535 in tab 531, as shown in FIG. 9(b). Aligned as such, bushing 537 is then dropped into mounting tab 531 such that stem 543 extends through bore 535 with enlarged head 541 of bushing 537 coming to rest directly on shelf 536, as shown in FIG. 9(c). With bushing 537 positioned as such, a threaded fastening element 547 (e.g., a screw, bolt, etc.) is driven through bore 545, as shown in FIG. 9(d), the threading on fastening element 547 engaging the portion of bushing 537 that immediately defines bore 545. Further advancement of fastening element 547 ultimately causes the free end of its threaded stem to be driven into engagement with the particular object to which plastic casing 511 is to be affixed. In this manner, the EAS device located within plastic casing 511 is coupled to the desired object in need of security monitoring.

With fastening element 547 driven through bushing 537 and into the desired object in the manner as described in detail above, it is to be understood that bushing 537 is free to rotate relative to mounting tab 531 and vice versa. Accordingly, if an unscrupulous consumer were to attempt to unscrew the fastening element 547 from the desired object by simply rotating cover 515, it is to be understood that, although cover 515 would rotate, bushing 537 would remain stationary. Because fastening element 547 is only in threaded engagement with bushing 537 and the desired object, it is to be understood that the rotation of cover 515 would not serve to unscrew element 547 from the object, which is highly desirable. To summarize, plastic casing 511 is specifically designed to prohibit an unscrupulous consumer from using the plastic case as a tool for separating the EAS tag 11 from the object in need of security monitoring and, as a consequence, this design feature serves a principal novel feature of the present invention.

The embodiments shown in the present invention are intended to be merely exemplary and those skilled in the art shall be able to make numerous variations and modifications to it without departing from the spirit of the present invention. For example, if the particular object to which an EAS device is secured is constructed out of a material that could impair the functionality of said device, it is to be understood that the thickness of the base for any of the above-described plastic casings could be increased (thereby increasing the degree of separation between the EAS device and the particular object) to the extent necessary to ensure proper operation of the EAS device. All such variations and modifications are intended to be within the scope of the present invention as defined in the appended claims.

What is claimed is:

1. A plastic case for encapsulating an EAS tag, the plastic case comprising:
(a) a base, and
(b) a cover pivotally coupled to the base by a hinge, the hinge enabling the plastic case to be disposed between an open position and an enclosed position,
(c) wherein, with the plastic case disposed in its enclosed position, the base and cover are sized and shaped to substantially encapsulate the EAS tag.

2. The plastic case as claimed in claim 1 wherein the plastic case is molded as a unitary device.

3. The plastic case as claimed in claim 1 wherein the base is adapted to support the EAS tag.

4. The plastic case as claimed in claim 3 wherein the cover is shaped to define a partially enclosed cavity that is sized and shaped to receive at least a portion of the base when the plastic case is disposed in its enclosed position.

5. The plastic case as claimed in claim 1 further comprising a locking device for retaining the plastic case in its enclosed position.

6. The plastic case as claimed in claim 5 wherein the base is shaped to include a ratchet-shaped locking finger, the finger being positioned to engage a portion of the cover when the plastic case is disposed in its enclosed position.

7. The plastic case as claimed in claim 1 further comprising at least one integrally formed mounting strap.

8. The plastic case as claimed in claim 7 further comprising a pair of integrally formed mounting straps, each mounting strap being shaped to include a plurality of ratchet teeth.

9. The plastic case as claimed in claim 8 wherein the plastic case is shaped to define a pair of slots, each slot being sized and shaped to receive an associated mounting strap, the plastic case being shaped to sequentially engage the plurality of ratchet teeth on each mounting strap as each mounting strap is fed through its associated slot.

10. The plastic case as claimed in claim 9 further comprising an integrally formed hook.

11. The plastic case as claimed in claim 1 further comprising a first projection, the first projection being shaped to define a longitudinal strap accepting slot.

12. The plastic case as claimed in claim 11 wherein the slot provided in the first projection is sized and shaped to fittingly receive the strap of a conventional cable tie.

13. The plastic case as claimed in claim 11 further comprising a second projection, the second projection being shaped to define a longitudinal strap.accepting slot, the first and second projections being spaced apart from one another.

14. The plastic case as claimed in claim 1 further comprising a pair of spaced apart mounting tabs.

15. The plastic case as claimed in claim 1 further comprising a bushing which is sized and shaped to mount within an elongated bore formed into the plastic case.

16. The plastic case as claimed in claim 15 wherein, with the bushing mounted within the elongated bore, the bushing is free to rotate independently of the remainder of the plastic case.

17. The plastic case as claimed in claim 16 wherein the plastic case is countersunk immediately surrounding the elongated bore so as to define an annular shelf.

18. The plastic case as claimed in claim 17 wherein the bushing includes an enlarged annular head and an elongated annular stem that are in co-axial alignment with one another.

19. The plastic case as claimed in claim 18 wherein, with the bushing mounted within the elongated bore, the enlarged annular head rests directly upon the annular shelf.

20. The plastic case as claimed in claim 19 wherein the bushing is releasably coupled to the remainder of the plastic case by at least one severable connector.
